(19) United States
(12) Patent Application Publication
(10) Pub. No.: US 2015/0015359 A1
(43) Pub. Date: Jan. 15, 2015

(54) SOFT MAGNETIC COMPOSITE, METHOD FOR PREPARING THE SAME, AND ELECTRONIC COMPONENTS INCLUDING THE SAME AS CORE MATERIAL

(71) Applicant: SAMSUNG ELECTRO-MECHANICS CO., LTD., Suwon-si (KR)

(72) Inventors: Hak Kwan KIM, Suwon-si (KR); Sang Kyun KWON, Suwon-si (KR); Sung Jae LEE, Suwon-si (KR); Sung Yong AN, Suwon-si (KR)

(21) Appl. No.: 14/330,817

(22) Filed: Jul. 14, 2014

(30) Foreign Application Priority Data
Jul. 15, 2013 (KR) 10-2013-0082852

(51) Int. Cl. H01F 27/255; B22F 1/00; B22F 3/14

(52) U.S. Cl. CPC H01F 27/255; B22F 3/14; B22F 1/007; B22F 2003/145
USPC 336/233; 419/12; 75/232; 252/62.55

(57) ABSTRACT

Disclosed herein are a soft magnetic composite including an insulating layer formed along an inter-particle boundary of a soft magnetic core metal powder, a method for preparing the same, and electronic components including the same as a core material.

The soft magnetic composite according to the present invention may include the insulating layer formed along the inter-particle boundary of the soft magnetic core metal particles, such that damage to a coating film caused by a molding of the existing soft magnetic powder having the insulation coating film formed therein may be prevented, whereby an eddy current loss may be minimized.

### CROSS REFERENCE(S) TO RELATED APPLICATIONS

This application claims the benefit under 35 U.S.C. Section 119 of Korean Patent Application Serial No. 10-2013-0082852, entitled “Soft Magnetic Composite, Method for Preparing the Same, and Electronic Components Including the Same as Core Material” filed on Jul. 15, 2013, which is hereby incorporated by reference in its entirety into this application.

### BACKGROUND OF THE INVENTION

1. Technical Field

The present invention relates to a soft magnetic composite, a method for preparing the same, and electronic components including the same as a core material.

2. Description of the Related Art

In general, a soft magnetic material has been used in various fields such as a core in an inductor, a stator and a rotator of an electric device such as a motor, an actuator, a sensor, and a core in a transformer.

The soft magnetic core such as the rotator and the stator of the electric device is generally prepared by stacking a number of fabricated steel plates and fixing them so as to be integrated. However, in the case in which the steel plates are stacked, it has difficulties in preparing a product having three dimensional complicated shapes, and problems in that a large loss in a scrap metal thereof is generated.

Therefore, recently, an improved core which is easily prepared and has a high degree of freedom in view of a shape thereof is prepared by high pressure molding the soft magnetic powder.

The soft magnetic powder to be used in this case, which is a powder having magnetism when electricity is applied thereto, is generally based on Fe-based soft magnetic particles, and the soft magnetic powder is used to prepare the soft magnetic core through a general powder metallurgical process. That is, after the powder is prepared as a powder form through a spraying method, a grinding method, or the like, a mechanical process or a heat treatment, or the like, is performed on the corresponding powder, such that the soft magnetic powder capable of being appropriately used as a core material may be prepared.

The soft magnetic powder has various shapes such as a round shape, a flat shape, a multiple shape, and the like, has a size which allows good molding density and magnetic flux density, and it is preferred that the soft magnetic powder has a uniform particle size through a sorting process.

An insulation coating is performed by mixing ceramic coating or epoxy coating the prepared soft magnetic powder. Here, the mixing ceramic to be added for the insulation coating is based on oxides having large resistance such as phosphate, silica (SiO₂), and sodium silicate, and the ceramic coating allows each powder to be electrically separated from each other, such that an eddy current loss in the core material is decreased. The insulation coating is performed as described above, such that the soft magnetic powder consists of a general soft magnetic composite (SMC).

The prepared soft magnetic powder is press-molded by using a press machine which is a compression molding machine, and a soft magnetic core molding body having desired shape is formed through the above-described processes.

In this case, in order to decrease an inter-particle eddy current loss in all soft magnetic powders, the insulation coating is performed to mold the powder, wherein even though the molding process for preparing the core is performed with dedicated attention, the insulated coating film may not be prevented from being partially damaged, such that the eddy current loss may be increased.

### RELATED ART DOCUMENT

### Patent Document

(Patent Document 1) Japanese Patent Laid-Open Publication No. JP 2010-209469

### SUMMARY OF THE INVENTION

An object of the present invention is to provide a soft magnetic composite capable of preventing damage to a coating film and decreasing an eddy current loss in preparing the soft magnetic composite by performing an insulation coating on a metal soft magnetic powder.

In addition, another object of the present invention is to provide a method for preparing the soft magnetic composite.

Further, another object of the present invention is to provide various electronic products including the soft magnetic composite as a core material.

According to a first exemplary embodiment of the present invention, there is provided a soft magnetic composite including an insulating layer formed along an inter-particle boundary of a soft magnetic core metal powder.

The soft magnetic core metal powder may be a α-Fe powder, or at least one Fe alloy powder selected from Fe—Si, Fe—Al—Si, and Fe—Si—Cr.

The soft magnetic core metal powder may have an average particle size D50 in a range of 100 to 200 μm.

The insulating layer may be made of an insulating material containing B₂O₃.

The soft magnetic composite may further include a low melting point lubricating powder having a melting point of 100 to 180° C.

The low melting point lubricating powder may be a stearic acid-based powder.

According to a second exemplary embodiment of the present invention, there is provided a method for preparing a soft magnetic composite, the method including: preparing a mixture by mixing a soft magnetic core metal powder, a lubricating powder, and an insulating powder; primarily warm-molding the mixture; and secondarily warm-molding the primarily warm-molded mold.

The soft magnetic composite may contain 0.1 to 0.5 wt % of the lubricating powder, 1 to 3 wt % of the insulating powder, and the residual amount of the soft magnetic core metal powder.

The primary warm-molding may be performed at 100 to 180° C. The primary warm-molding may be performed under a pressure of 100 to 300 MPa.

At the time of the primarily warm-molding, the lubricating powder may be dissolved to decrease frictional force between each powder consisting of the mixture.

The secondary warm-molding may be performed at 400 to 500° C. The secondary warm-molding may be performed under a pressure of 900 to 1200 MPa.

At the time of the secondarily warm-molding, the insulating powder may be dissolved and infiltrated into an inter-particle boundary of the soft magnetic core metal powder, such that an insulating layer may be formed along the inter-particle boundary of the soft magnetic core metal powder.

According to a third exemplary embodiment of the present invention, there is provided an electronic component including the soft magnetic composite as described above as a core material.

The electronic component may be any one selected from an inductor, a motor, an actuator, a sensor, a transformer, and a reactor.

### BRIEF DESCRIPTION OF THE DRAWINGS

FIG. 1 shows a structure of a soft magnetic composite according to an exemplary embodiment of the present invention;

FIG. 2 is a view showing a process for preparing the soft magnetic composite according to the exemplary embodiment of the present invention;

FIG. 3 shows a result obtained by confirming a structure of the soft magnetic composite prepared by Example 1 of the present invention; and

FIG. 4 shows a result obtained by measuring an eddy current loss in toroid samples prepared by Example 2 and Control Group 1 using a B—H analyzer while frequency is changed from 100 kHz to 700 kHz.

### DESCRIPTION OF THE PREFERRED EMBODIMENTS

Hereinafter, the present invention will be described in more detail.

Terms used in the present specification are used for explaining specific embodiments rather than limiting the present invention. Unless explicitly described to the contrary, a singular form may include a plural form in the present specification. In addition, the word “comprise” and variations such as “comprises” or “comprising,” will be understood to imply the inclusion of stated constituents, numbers, steps, operations, members, and/or elements but not the exclusion of any other constituents, numbers, steps, operations, member, and/or elements.

The present invention provides a soft magnetic composite, a method for preparing the same, and various electronic components including the same as a core material.

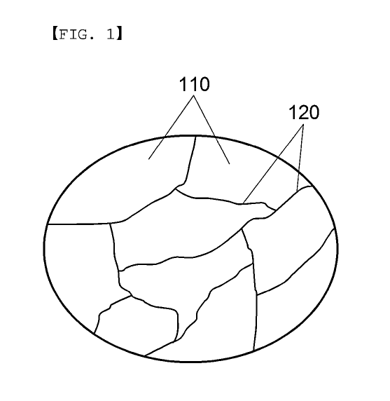

The soft magnetic composite according to an exemplary embodiment of the present invention may include an insulating layer 120 formed along an inter-particle boundary of a soft magnetic core metal powder 110 as shown in FIG. 1.

According to the exemplary embodiment of the present invention, a molding density may be increased and damage to an insulation coating film may be minimized at the time of preparing a general low iron-loss soft magnetic composite (SMC) core. That is, according to the exemplary embodiment of the present invention, the insulation coating of the soft magnetic core metal powder is not performed in a powder state, but the insulating layer is ultimately formed along the inter-particle boundary of the soft magnetic metal powder in the core through a two-stage core molding and a heat treatment.

Therefore, after the insulation coating is previously performed on the soft magnetic core metal powder according to the related art, damage to the insulation coating film caused by the molding may be basically prevented, whereby an eddy current loss may be minimized.

As the soft magnetic core metal powder according to the exemplary embodiment of the present invention, a metal powder having high permeability and moldability, and consisting of only α-Fe (ferrite) phase capable of being relatively used in a low frequency band may be used.

In addition, in order to be used in the case in which the core loss in the high frequency is seriously considered, Fe alloys such as Fe—Si, Fe—Al—Si, Fe—Si—Cr, and the like, may be used.

A particle size is different depending on an available frequency, but it is preferred that an average particle D50 generally has a range of 100 to 200 μm.

In addition, the insulating layer may be made of an insulating material containing B₂O₃, wherein the insulating material becomes a liquid phase at the time of a warm-molding, such that the insulating layer is formed along the inter-particle boundary of the soft magnetic core metal powder.

The insulating material according to the exemplary embodiment of the present invention is preferably B₂O₃ having a high energy band gap of 8.45 eV, and a melting point of 450.

In addition, the soft magnetic composite according to the exemplary embodiment of the present invention may further include a low melting point lubricating powder having a melting point of 100 to 180, wherein the low melting point lubricating powder is dissolved at the time of primarily warm-molding to be the liquid phase, thereby decreasing frictional force of a mixture.

It is preferred that the low melting point lubricating powder is a stearic acid-based powder, and specific examples thereof may include a stearic acid, stearate, a stearic acid soap, ethylenebisstearamide, and the like, but the present invention is not limited thereto.

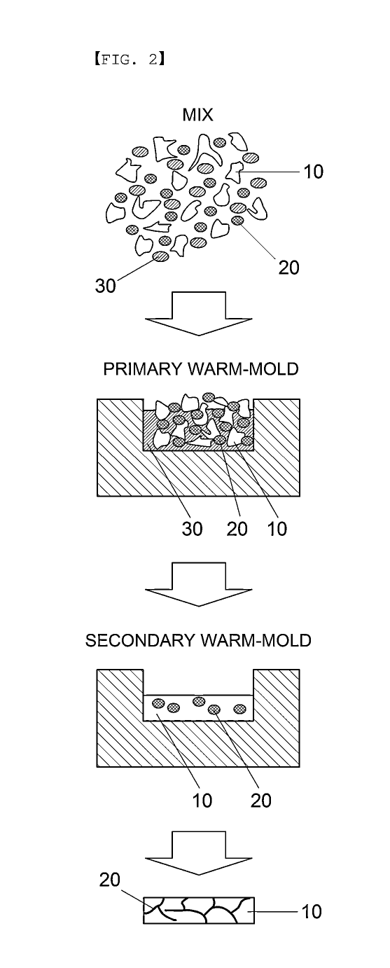

The method for preparing the soft magnetic composite according to the exemplary embodiment of the present invention may include preparing the mixture by mixing the soft magnetic core metal powder 10, the lubricating powder 30, and the insulating powder 20, primarily warm-molding the mixture, and secondarily warm-molding the primarily warm-molded mold, as shown in FIG. 2.

In the preparing of the mixture, the soft magnetic core metal powder, the lubricating powder, and the insulating powder consisting of the soft magnetic composite are mixed, wherein it is preferred that the mixture has an amount of 100 wt % by mixing 0.1 to 0.5 wt % of the lubricating powder, 1 to 3 wt % of the insulating powder, and the residual amount of the soft magnetic core metal powder.

Then, the primary warm-molding is performed on the mixed mixture, wherein the primary warm-molding may be performed after the mixture is put into a mold having a certain shape and preheated at 80. Next, the mixture is maintained at a temperature of 100 to 180 at which the lubricating powder is capable of being maintained in the liquid phase for 10 to 30 minutes to have sufficient viscosity, and then the molding is performed, which is preferred in that the frictional force between the mold and the mixing powder, and between the powders consisting of the mixture may be minimized. In addition, in this case, the molding may be performed under a pressure of 100 to 300 MPa.

At the time of the primarily warm-molding, the lubricating powder 30 contained in the mixture is dissolved to decrease the frictional force of the mixture. Therefore, as shown in FIG. 2, at the time of the primarily warm-molding, the lubricating powder 30 is dissolved to be served as a solvent, wherein the soft magnetic core metal powder 10 and the insulating powder 20 are dispersed in the solvent.

Then, a secondary warm-molding is performed on the primarily warm-molded mold, wherein the secondary warm-molding is performed at 400 to 500 for 10 to 30 minutes, which is preferred in that the insulating material may be effectively infiltrated along the inter-particle boundary of the soft magnetic core metal powder. In addition, in this case, the molding may be performed under a pressure of 900 to 1200 MPa for a high density filling.

At the time of the secondarily warm-molding, the insulating powder 20 is dissolved, such that the insulating layer is formed along the inter-particle boundary of the soft magnetic core metal powder 10.

That is, at the time of the secondarily warm-molding, the insulating powder 20 is dissolved to be liquid phase, and B₂O₃ which is the insulating material in the liquid phase is infiltrated into the inter-particle boundary of the soft magnetic core metal powder, such that the insulating layer is formed along the inter-particle boundary between the soft magnetic core metal particles to block the eddy current, whereby the core capable of decreasing the eddy current at the high frequency may be molded.

In the case in which the insulation coating is previously performed on the powder according to the related art, the damage to the coating film may not be completely prevented at the time of molding, but in the method according to the exemplary embodiment of the present invention, the insulation coating film is naturally formed on the inter-particle boundary during the core molding process, such that the damage to the coating film may be prevented.

Therefore, the finally prepared soft magnetic composite has a structure in which the insulating layer 120 made of the insulating powder is formed along the inter-particle boundary of the soft magnetic core metal powder 110 as shown in FIG. 1.

With the soft magnetic composite having the above-described structure according to the exemplary embodiment of the present invention, the density of the core may be increased and the eddy current loss may be effectively decreased, as compared to the core made of a Fe-powder or a Fe-based alloy powder in which the insulation coating is previously performed according to the related art.

In addition, the present invention may provide an electronic component including the soft magnetic composite as the core material.

The electronic component may be any one selected from an inductor, a motor, an actuator, a sensor, a transformer, and a reactor, but the present invention is not limited thereto.

Hereinafter, preferred examples of the present invention will be described in detail. The examples below are described by way of an example, and therefore, the scope of the present specification and claims should not be interpreted as being limited to the example. In addition, the examples below are exemplified using specific compounds, but it is obvious to those skilled in the art that an effect obtained by using equivalents thereof can be the same as or similar to that of the present invention.

### EXAMPLE 1

10 g of α-Fe powder having an average particle size D50 of 100 μm, 0.3 wt % of zinc stearic acid as a lubricating powder, and 1.5 wt % of B₂O₃ as an insulating powder were mixed to prepare a mixture in an amount of 100 wt %.

The mixture was infiltrated into a mold having a hydraulic press mounted thereon for preparing a sample, and primarily warm-molded under a pressure of 130 Mpa at 150 for 20 minutes.

In addition, the primarily warm-molded mold was secondarily warm-molded under a pressure of 1000 Mpa at 500 for 30 minutes to thereby prepare a final soft magnetic composite.

### EXPERIMENTAL EXAMPLE 1

### Confirmation of Structure

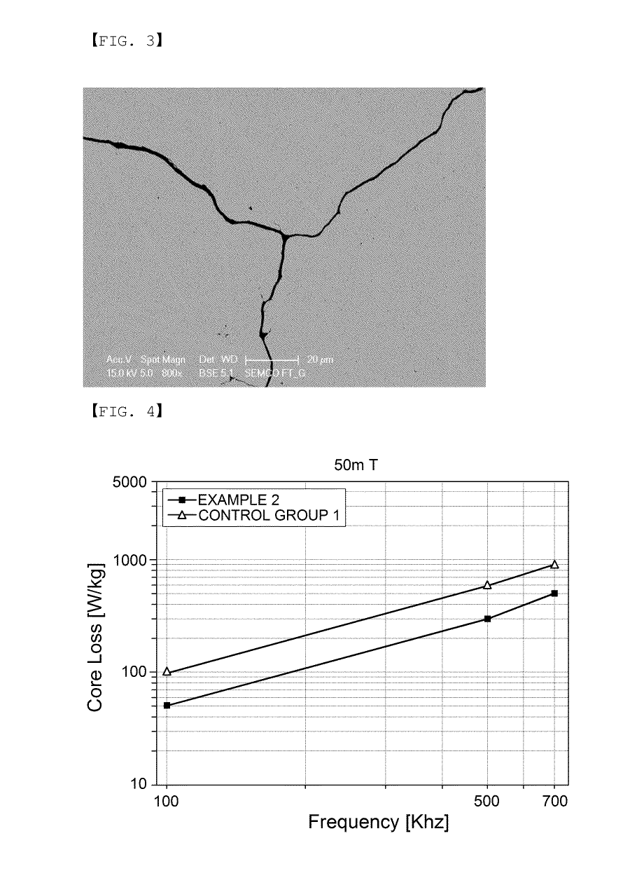

A structure of the soft magnetic composite prepared by the Example 1 of the present invention was observed by using a scanning electron microscope (SEM), and the result thereof was shown in FIG. 3.

Referring to FIG. 3, which is a photograph obtained by observing a cross-section of an actually molded core using the SEM, it is clearly observed in a back scattered image mode that contrast due to a difference in mass between Fe and B is formed along the inter-particle boundary of the powder. In the case of B, it is difficult to perform a qualitative analysis of an element by energy dispersive spectrometer (EDS) due to a low atomic number, such that the above-described observation was used.

### EXAMPLE 2

### Preparation of Toroid Sample for Magnetic Property

The soft magnetic composite prepared by Example 1 of the present invention was used to prepare a toroid sample. The sample according to Example 2 of the present invention was prepared by the general method.

### Control Group 1

A toroid sample as a control group was prepared by the same method as Example 2 of the present invention except for using an untreated α-Fe powder as a core material.

### EXPERIMENTAL EXAMPLE 2

### Measurement of Eddy Current Loss

An eddy current loss in toroid samples prepared by Example 2 and Control Group 1 was measured by using a B—H analyzer while frequency is changed from 100 kHz to 700 kHz, and the result thereof was shown in FIG. 4.

It may be appreciated from FIG. 4 that the core loss indicating the eddy current loss in the Control Group 1 is larger than that of Example 2 in every frequency band. That is, it may be appreciated that in the Control Group 1 in which the insulation coating is not performed between the powder particles formed in the core, a size of the eddy current formed between the particles is large as compared to Example 2, and when considering that FIG. 4 is a log scale function, as the frequency is increased, the eddy current loss is also increased.

According to the exemplary embodiment of the present invention, the low iron-loss soft magnetic composite having the high density may be prepared by the simplified entire process without the insulation coating process of the soft magnetic core metal powder.

In addition, the soft magnetic composite according to the exemplary embodiment of the present invention may include the insulating layer formed along the inter-particle boundary of the soft magnetic core metal particles, such that the damage to the coating film caused by the molding of the soft magnetic powder having the insulation coating film formed therein according to the related art may be prevented, whereby the eddy current loss may be minimized.

Therefore, in the case in which the soft magnetic composite according to the exemplary embodiment of the present invention is used as the core material, it is advantageous to manufacture the motor having high efficiency, and the cost for preparing the core is decreased, such that the soft magnetic composite has the price competitiveness advantage, thereby being used as the core material in various electronic components.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A soft magnetic composite comprising an insulating layer formed along an inter-particle boundary of a soft magnetic core metal powder.

2. The soft magnetic composite according to claim 1, wherein the soft magnetic core metal powder is a α-Fe powder, or at least one Fe alloy powder selected from Fe—Si, Fe—Al—Si, and Fe—Si—Cr.

3. The soft magnetic composite according to claim 1, wherein the soft magnetic core metal powder has an average particle size D50 in a range of 100 to 200 μm.

4. The soft magnetic composite according to claim 1, wherein the insulating layer is made of an insulating material containing B₂O₃.

5. The soft magnetic composite according to claim 1, further comprising a low melting point lubricating powder having a melting point of 100 to 500.

6. The soft magnetic composite according to claim 1, wherein the low melting point lubricating powder is a stearic acid-based powder.

7. A method for preparing a soft magnetic composite, the method comprising:
preparing a mixture by mixing a soft magnetic core metal powder, a lubricating powder, and an insulating powder;
primarily warm-molding the mixture; and
secondarily warm-molding the primarily warm-molded mold.

8. The method according to claim 7, wherein the soft magnetic composite contains 0.1 to 0.5 wt % of the lubricating powder, 1 to 3 wt % of the insulating powder, and the residual amount of the soft magnetic core metal powder.

9. The method according to claim 7, wherein the primary warm-molding is performed at 100 to 180.

10. The method according to claim 7, wherein the primary warm-molding is performed under a pressure of 100 to 300 MPa.

11. The method according to claim 7, wherein at the time of the primarily warm-molding, the lubricating powder is dissolved to decrease frictional force between each powder consisting of the mixture.

12. The method according to claim 7, wherein the secondary warm-molding is performed at 400 to 500.

13. The method according to claim 7, wherein the secondary warm-molding is performed under a pressure of 900 to 1200 MPa.

14. The method according to claim 7, wherein at the time of the secondarily warm-molding, the insulating powder is dissolved and infiltrated into an inter-particle boundary of the soft magnetic core metal powder, such that an insulating layer is formed along the inter-particle boundary of the soft magnetic core metal powder.

15. An electronic component comprising the soft magnetic composite according to claim 1 as a core material.

16. The electronic component according to claim 15, wherein it is any one selected from an inductor, a motor, an actuator, a sensor, a transformer, and a reactor.
